(19) United States
(12) Patent Application Publication
(10) Pub. No.: US 2026/0249938 A1
(43) Pub. Date: Aug. 27, 2026

(54) MODULAR VEHICLE ARCHITECTURE FOR ASSEMBLING VEHICLES

(71) Applicant: Tesla, lnc., Austin, TX (US)

(72) Inventors: Brian Paul Greviskes, Chicago, IL (US); Paul J. Venhovens, Redondo Beach, CA (US); Gregory Lucas Peer, San Francisco, CA (US); Malcolm Burgess, Austin, TX (US); Adip Rai, Austin, TX (US); Sachin Shrimant Sawant, South Lake Tahoe, CA (US); Nils Petter Winberg, Torslanda (SE); Mubeen Ahmad, Fremont, CA (US); Veera Aditya Choudary Yerra, Marina Del Rey, CA (US); Mitchell Heinzmann, Austin, TX (US); Tom Spencer, Bellamystraat (NL); Lars Moravy, Oakland, CA (US)

(21) Appl. No.: 19/159,407

(22) PCT Filed: Feb. 27, 2024
(86) PCT No.: PCT/US2024/017537

§ 371 Date: Aug. 25, 2025

Related U.S. Application Data
(60) Provisional application No. 63/448,972, filed on Feb. 28, 2023.

(51) Int. Cl. B62D 65/04; B62D 27/06; B62D 65/06

(52) U.S. Cl. CPC B62D 65/04; B62D 27/065; B62D 65/06

(57) ABSTRACT

A modular vehicle architecture for efficiently assembling vehicles. The modular vehicle architecture includes preparing a plurality of individual section of a vehicle in a plurality of sub-assembly lines prior to forming a full body frame of the vehicle. The vehicle architecture further includes joining the plurality of individual sections of the vehicle in a mainline. The full body frame of the vehicle can include a front side, a rear side, a top side, a bottom side, a left side, and a right side.

### CROSS-REFERENCE TO RELATED APPLICATIONS

This application claims priority to U.S. Prov. Patent Application No. 63/448,972 titled “MODULAR VEHICLE ARCHITECTURE FOR ASSEMBLING VEHICLES” and filed on Feb. 28, 2023, the disclosure of which is hereby incorporated herein by reference in its entirety.

### TECHNICAL FIELD

The present application relates to an architecture for assembling vehicles. More particularly, one or more aspects of the present application relate to systems and methods for efficiently assembling vehicles in modules.

### SUMMARY

The disclosure relates generally to a vehicle architecture for assembling vehicles. More specifically, various embodiments of this disclosure relate to vehicle architecture for assembling a vehicle in sections prior to joining a body frame of the vehicle,

An aspect is directed to a method for assembling a vehicle, the method including preparing a plurality of individual sections of a vehicle in a plurality of sub-assembly lines prior to forming a full body frame of the vehicle. The method further includes joining the plurality of individual sections of the vehicle in a mainline. The full body frame of the vehicle includes a front side, a rear side, a top side, a bottom side, a left side, and a right side.

Another aspect is directed to a vehicle assembling line including a plurality of sub-assembly lines configured to at least paint a plurality of individual sections of a vehicle. The vehicle assembling line further includes a mainline configured to join the plurality of individual sections of the vehicle to form a full body frame of the vehicle. The full body frame of the vehicle includes a front side, a rear side, a top side, a bottom side, a left side, and a right side.

### BRIEF DESCRIPTION OF THE DRAWINGS

The present disclosure is described with reference to the accompanying drawings, in which like reference characters reference like elements, and wherein:

FIG. 1 illustrates side and top views of sections of a pick-up truck to be joined according to an embodiment of a vehicle architecture according to this disclosure.

FIG. 2A illustrates side views of sections of the pick-up truck in FIG. 1 being assembled according to the vehicle architecture.

FIG. 2B illustrates top views of sections of the pick-up truck in FIG. 1 being assembled according to the vehicle architecture.

FIG. 3A is a top perspective view of a body frame of a vehicle assembled according to an embodiment of a vehicle architecture according to this disclosure.

FIG. 3B is a top perspective view of separate sections making up the body frame of the vehicle in FIG. 3A.

FIG. 4 is a top perspective view of the separate sections in FIG. 3B being joined to form the body frame in FIG. 3A.

FIG. 5A is a flowchart of an example process for manufacturing a vehicle according to the techniques described herein.

FIG. 5B illustrates top perspective views of one or more sections of a vehicle body frame being joined according to an embodiment of a vehicle architecture according to this disclosure.

FIG. 5C is a block diagram illustrating processes of the vehicle architecture of FIG. 5B.

FIG. 6A illustrates top perspective views of one or more sections of a vehicle body frame being joined according to an embodiment of a vehicle architecture according to this disclosure.

FIG. 6B is a block diagram illustrating processes of the vehicle architecture of FIG. 6A.

FIG. 7A illustrates a top perspective view of one or more sections of a vehicle body frame being joined according to an embodiment of a vehicle architecture according to this disclosure.

FIG. 7B is a block diagram illustrating processes of the vehicle architecture of FIG. 7A.

FIG. 8A illustrates an embodiment of a vehicle architectures unboxing 2 and ½ faces of the “box” of a vehicle.

FIG. 8B illustrates an embodiment of a vehicle architectures unboxing 3 faces of the “box” of a vehicle.

FIG. 8C illustrates an embodiment of a vehicle architectures unboxing 5 faces of the “box” of a vehicle.

FIG. 8D illustrates an embodiment of a vehicle architectures unboxing 6 faces of the “box” of a vehicle.

FIG. 9A illustrates close-up views of a stamped hinge pillar section with a jogged inboard mounting flange according to this disclosure.

FIG. 9B illustrates side views of a staggered bolt pattern with the bolt positions varying in the horizontal (x) and vertical (y) directions according to this disclosure.

FIG. 9C illustrate close-up views of a stamped hinge pillar section with forward flanges according to this disclosure.

FIG. 10 is a top perspective view of a vehicle frame illustrating a joining technique according to this disclosure,

FIG. 11A illustrates one example of how corners and edges between sections of a vehicle frame can be sealed according to this disclosure.

FIG. 11B illustrates another example of how corners and edges between sections of a vehicle frame can be sealed according to this disclosure.

FIG. 12A is a top perspective view of an embodiment of a framing station for joining sections of a vehicle frame according to this disclosure.

FIG. 12B is a top perspective view of another embodiment of a framing station for joining sections of a vehicle frame according to this disclosure.

FIG. 13 is a top perspective view and a side view of an automated framing station for joining sections of a vehicle frame according to this disclosure.

FIGS. 14A-14C illustrate example processes by which a vehicle may be manufactured.

### DETAILED DESCRIPTION

Generally described, vehicles are often assembled and manufactured in a specific sequence by building the welded frame, or “box,” of the vehicle first (e.g., a vehicle body). Traditional vehicle manufacturing utilizes welding of stamped panels to construct the vehicle body. The body or “box” is then transported through an e-coat system to provide a corrosion-resistance coating, and then is painted. The painted body is then moved to a “General Assembly” (also referred to herein as GA) shop, where internal and external components of the vehicle are assembled (e.g., instrument panels, seats, doors, trims, and so on). This traditional assembly process drives inefficiency in material handling and transport as the entire weight/footprint of the vehicle must be transported in order to assemble even small components (e.g., headlamps, thermal bars, wheels, and so on). The process also limits the ability to automate many of the manufacturing steps, as it becomes difficult/expensive to datum/locate the assembly at the full vehicle level.

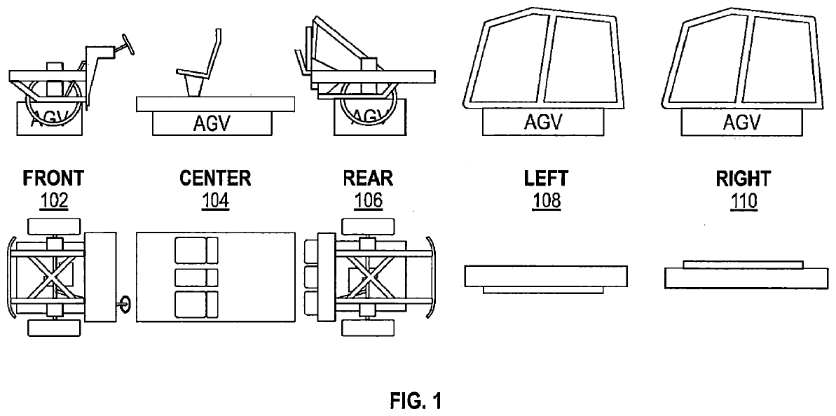

An aspect of this disclosure relates to a vehicle architecture that reduces the need to weld stamped panels. In some embodiments, no welding is used to connect major portions of the vehicle (e.g., portions illustrated in FIG. 1). Additionally, the vehicle architecture may avoid secondary decorating (e.g., coating/painting) at the full vehicle assembly level. In certain embodiments, the vehicle is designed such that it can be built in sections or modules and joined in a final assembly operation. In certain embodiments, this assembly operation can be accomplished after welding operations and metal surface treatment operations (e.g., e-coat, paint, and so on) have been applied, eliminating the need for traditional full-body-scale body and paint shops in automotive manufacturing. In some embodiments, the assembly operation can include, for example, a bolting or riveting operation. In some embodiments, the assembly operation can include a stir welding operation. In some embodiments, the sections can utilize large-scale castings or smaller stamped and welded assemblies.

Another aspect of the disclosure is that the modular vehicle architecture can include assembling the body or “box” of the vehicle after the internal components have been assembled to individual sections or modules of the vehicle. This allows the length of the GA line to be reduced. In various embodiments, by “unboxing” the assembly processes, individual sub-lines can also be reduced and/or run in parallel to one another, which may improve speed to ramp new factories (e.g., to get new factories to produce at design capacity), and may allow buffering in sub-assembly lines prior to GA and reduce downtime in GA. Accordingly, various embodiments of the modular vehicle architecture may reduce the factory footprint, complexity, utility requirements, and labor required to produce vehicles, and may also increase the overall equipment efficiency (OEE) of the factory as a whole.

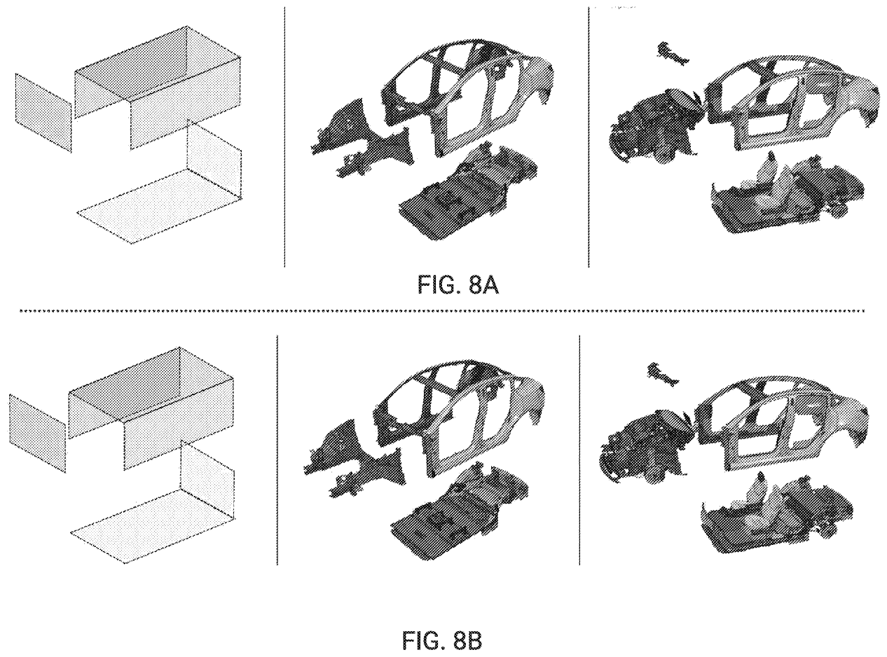

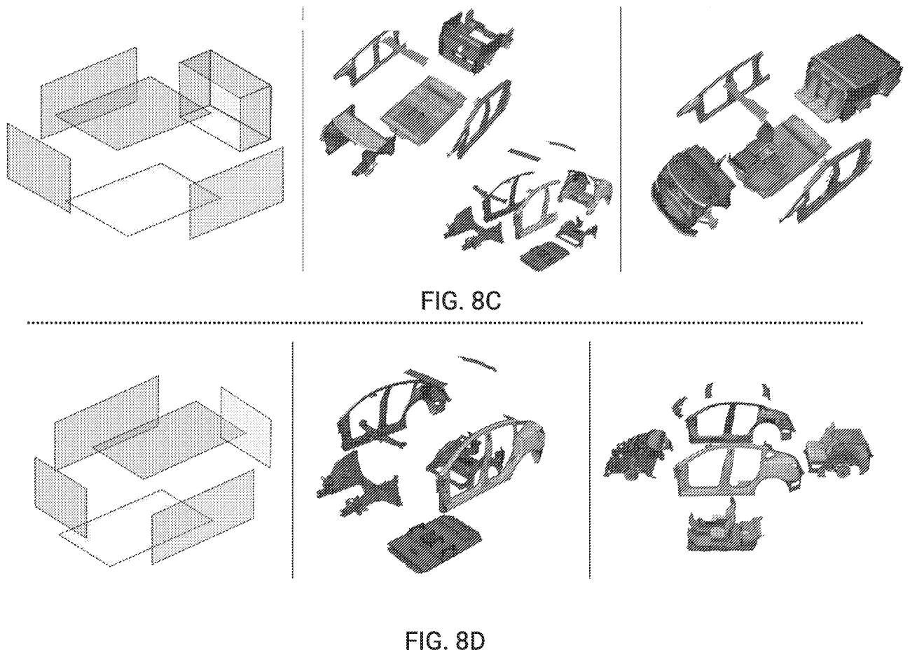

In some embodiments, a modular vehicle architecture includes assembling sub-components in separate sections or modules before joining (e.g., by bolting or other techniques as described herein) a body frame, or box, of the vehicle. As will be described in FIGS. 8A-8D, the body frame or box of the vehicle may be assembled in different ways which enable manufacturing parallelism as described herein. An exemplary embodiment of a modular vehicle architecture can include decorating (e.g., coating and/or painting) sub-components including, for example, left and right door rings, front underbody (hereinafter FUB), cowl, and so on, prior to joining the body frame of the vehicle.

In accordance with various embodiments, the modular vehicle architecture can further include one or more major sub-assembly lines (sub-lines). In some embodiments, individual major sub-lines may be operated separately and/or in parallel to one another. In some embodiments, the one or more major sub-lines can include a front underbody line, the front underbody line including, for example, a front underbody. In some embodiments, the front underbody line can also include a chassis, a thermal system, a cockpit, and so on. In some embodiments, the one or more major sub-lines can include a rear underbody line, the rear underbody line including, for example, a rear underbody (RUB). In some embodiments, the rear underbody line can also include a chassis, a tonneau, rear seats, and so on.

The modular vehicle architecture can further include a mainline for joining the assembled sections from the one or more major sub-lines and other components of the vehicle body, for example, left and right door rings. In some embodiments, the vehicle may be assembled into a complete product after the mainline.

As may be appreciated, the above-described sub-assembly lines may be operated using robotic techniques such that the lines operate semi or fully autonomously. For example, control systems (e.g., processors or microcontrollers) may be used to operate the manufacturing line using robotic techniques, hot-stamping techniques (e.g., to form panels, such as a single or double door ring), and so on. Subsequently, the sub-assembly lines may feed downstream into the general assembly. In some embodiments, the general assembly may utilize autonomous or semi-autonomous techniques to join the inputs to the general assembly. In some embodiments, the sub-assembly lines may use personnel.

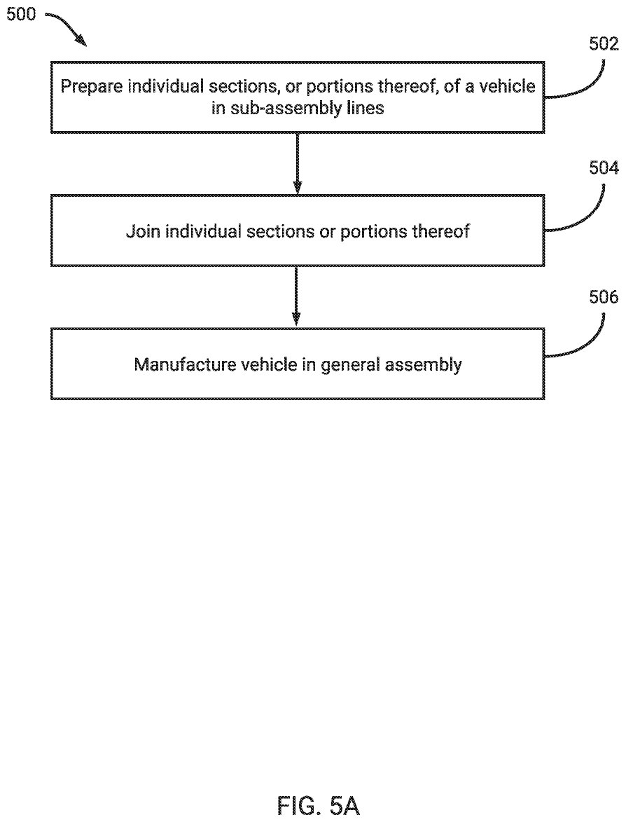

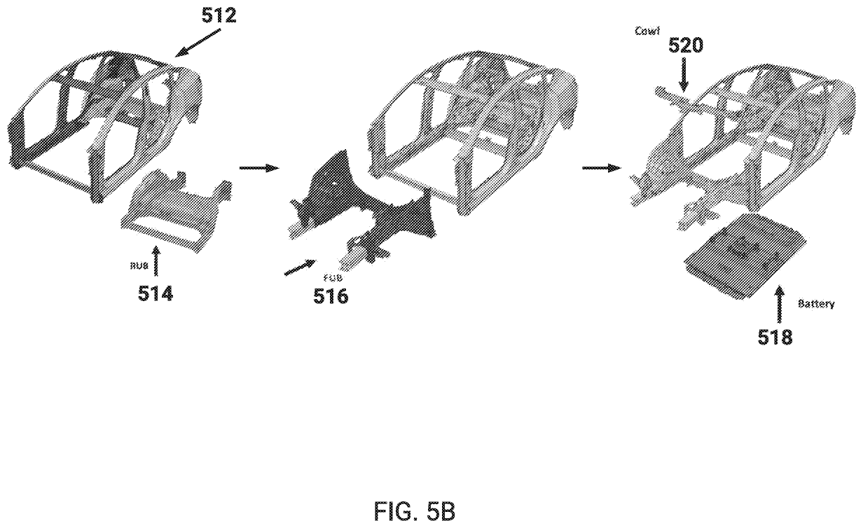

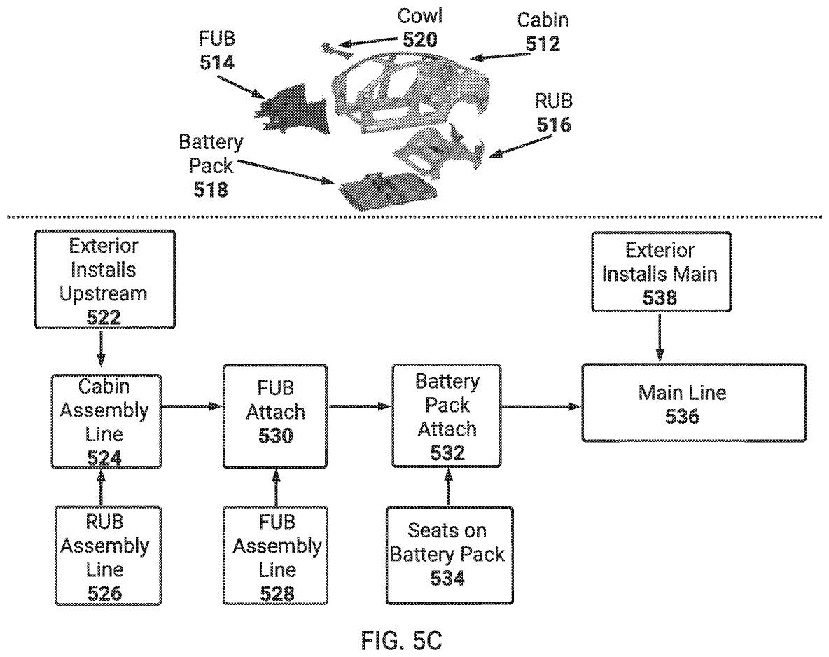

The techniques described herein therefore increase a throughput associated with manufacturing vehicles. Indeed, the complex current technique by which pieces of a vehicle are serially manufactured and assembled to form the vehicle may be discarded in favor of enhanced parallelism. As will be described, the major portions of a vehicle may be rapidly assembled (e.g., bolted together, such as using robotic techniques to effectuate the bolting in a short amount of time, such as 10 seconds, 20 seconds, and so on) with the major portions being, in some embodiments, assembled separately. In this way, the manufacturing line may not suffer delays due to delays in certain steps which unnecessarily constrain the manufacturing line. Furthermore, the use of the parallelism described herein may enhance a volumetric efficiency of the manufacturing line. For example, and as described at least in FIGS. 5A-7B, the sub-assemblies may be organized to enhance the use of space while also increasing throughput.

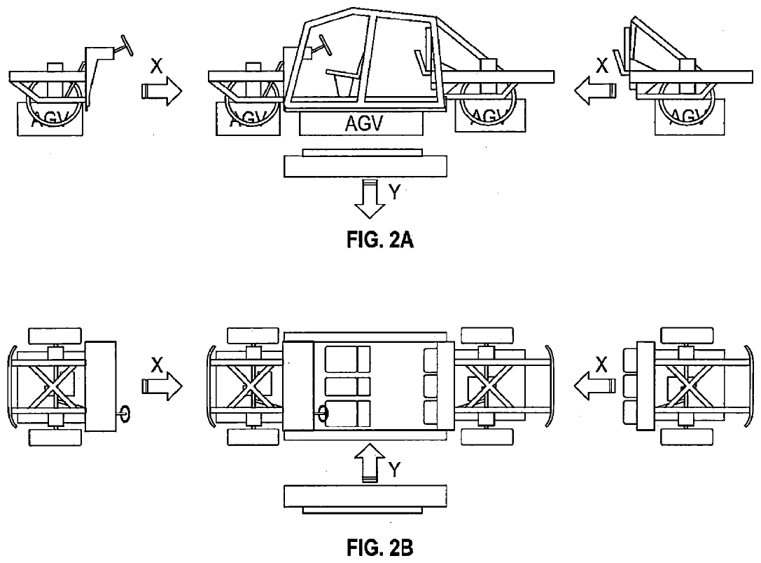

As illustrated in FIGS. 1-2B, a modular vehicle architecture according to this disclosure can include a multitude of major sub-assemblies or sections 102-110, each assembled in a sub-line and then joined together using automated guided vehicles (AGVs). For example, the modular vehicle architecture can include a front section 102, a center section 104, a rear section 106, a left section 108, and a right section 110. In the illustrated embodiment, the center 104 may include one or more seats connected (e.g., bolted) to the lower portion of the sub-assembly 104. In some embodiments, the center 104 may include an electric vehicle battery pack under the lower portion. In some embodiments, the electric vehicle battery pack may form the lower portion of the center 104.

The left and right sub-assemblies 108-110 may represent a door ring, with FIG. 1 illustrating a double door ring. In some embodiments, the door ring may be hot stamped such that a manufacturing time may be rapidly increased as compared to current techniques.

As illustrated in FIGS. 2A-2B, in some embodiments the sections 102-110 can be each placed on an AGV and joined together to form a vehicle body in a horizontal plane (e.g., x-y plane, without fasteners from the bottom). For example, and with respect to one example perspective, the front section 102 may be moved along a negative X-direction, the rear section 106 may be moved along a positive X-direction, the left section 108 may be moved along a negative Y-direction, and the right section 110 may be moved along a positive Y-direction. These sections may thus be moved inwards towards the center 104. Advantageously, the joining of these sections may avoid welding. For example, they may be bolted together to quickly form the vehicle.

FIGS. 5A-7B describe example techniques to manufacture example sections, which in some embodiments may be the sections 102-110 illustrated in FIGS. 1-2B. As may be appreciated, the sections 102-110 may be manufactured separately and joined together. In some embodiments, certain sections may be manufactured together and then subsequently joined. For example, FIGS. 5B-5C illustrate examples of a cabin assembly line which is provided to a front underbody (FUB) attachment assembly line, and to a battery pack attachment assembly line (e.g., with seats on the battery pack as described above), and then to general assembly.

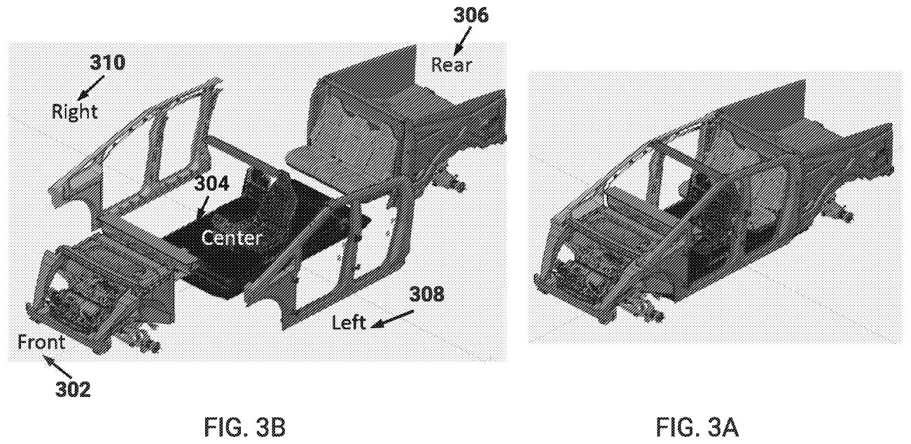

FIG. 3A illustrates another embodiment of a modular vehicle architecture that includes use of major sections 302-310, including but not limited to a front section 302, a center section 304, a rear section 306, a left section 308, and a right section 310. In the illustrated example, the vehicle is a truck however other vehicles may be manufactured according and fall within the present disclosure. FIG. 3B illustrates the major sections 302-310 being joined (e.g., connected, such as bolting, fastening, and so on).

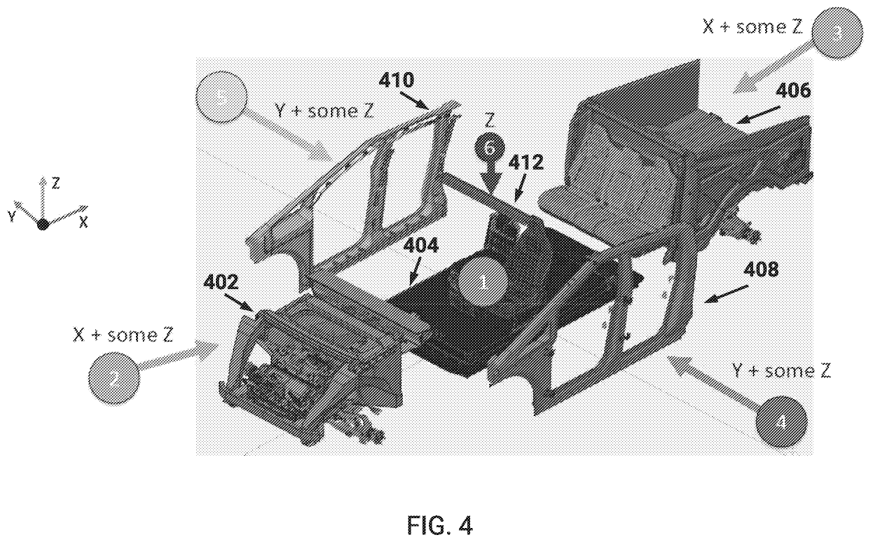

FIG. 4 is a top perspective view of the separate sections in FIG. 3A being joined to form the body frame in FIG. 3B. After being assembled in their respective sub-lines, each of the sections 402-410 (e.g., sections 302-310) can be brought together to form a vehicle body utilizing not only a path in a horizontal plane (e.g., plane x-y) but also additional paths and in a specific sequence.

As one example, the center section 404 (e.g., section 304) can first be placed in a central position. The front section 402 (e.g., section 302) may then be moved towards and attached to the center section 404 from a front side in a vertical plane (e.g., plane x-z). The rear section 406 (e.g., section 306) can then be moved towards and attached to the center section 404 from a rear side in the vertical plane.

Subsequently, with respect to the example above, the left section 408 (e.g., section 308) can be moved towards and attached to the center section 404 from a left side towards the center section 404 in a transverse plane (e.g., plane y-z). The right section 410 (e.g., section 310) can then be moved towards and attached to the center section from a right side towards the center section 404 in the transverse plane. Finally, a top panel 412 (e.g., a cowl) can be moved towards and attached to the center section 404 in a vertical direction (e.g., axis z).

While the above described is one example of ordering of moving sections to form a body, it should be appreciated different orders may be used and fall within the scope of the disclosure herein.

FIGS. 5A-7B illustrates additional embodiments of vehicle architectures that “unbox” the body frame of a vehicle, at least partially, by assembling sections of the vehicle in sub-lines before joining the vehicle body together.

FIG. 5A is a flowchart of an example process 500 for manufacturing a vehicle according to the techniques described herein. The process 500 may be performed via a manufacturing line (e.g., a vehicle assembling line) and may use one or more framing stations as described herein. In some embodiments, the process 500 may be performed via processors or microcontrollers which automate the manufacturing line.

At block 502, individual sections, or portions thereof, of a vehicle are prepared in sub-assembly lines. As described herein, sections of the vehicle may include a front, rear, left, right, top, bottom, and so on sections. These sections may be prepared in individual sub-assembly lines and portions thereof may have their own sub-assembly lines to parallelize manufacturing. In some embodiments, the individual sections may be decorated (e.g., painted) prior to forming the box or body of the vehicle. Examples of such preparation are described herein with respect to FIGS. 5B-7B and 14A-14C.

At block 504, individual sections or portions thereof are joined. An individual section may have portions joined to form the individual section. In some embodiments, the portions may be joined via bolting and may not use welds. Similarly, the individual sections may be joined (e.g., to form a box or body as described herein) via bolting or other techniques and in some embodiments may not use welding for joining. The bolting may occur from the outside going inward to increase throughput and ease of such bolting. Examples of such joining are described herein, with respect to at least FIGS. 5B-7B and 14A-14C.

At block 506, the vehicle is manufactured in general assembly (e.g., a mainline). The vehicle may undergo certain finishing steps, such as installation of exterior elements.

As shown in FIGS. 5B-5C, a modular vehicle architecture according to this disclosure may include separating a rear underbody section 514 (RUB), a front underbody section 516 (FUB), a battery pack 518, and a cowl 520 from the main body frame 512 of a vehicle. The vehicle architecture can be separately prepared (e.g., decorated, such as via painting) in sub-lines (e.g., sub-assembly lines) prior to being assembled (e.g., as illustrated with respect to the arrows in FIG. 5B). This separation improves the efficiency of the assembly process as compared to a traditional assembly process.

In some embodiments, the vehicle architecture can include joining and fastening (e.g., using bolts) the sections in a specific sequence and orientations as illustrated. For example, the body frame 512 may be joined with the RUB 514. The FUB 516 may then be joined. The battery pack 518 and cowl 520 may then be joined. For example, the battery pack 518 may be joined in the upward direction (e.g., positive z direction) and the cowl 520 may be joined in the downward direction (e.g., negative z direction). FIG. 5C describes the sub-lines and main line of the vehicle architecture in Figure SB in greater details.

FIG. 5B illustrates an example process for manufacturing a vehicle. The illustrated embodiment specifically relates to manufacturing a vehicle using the sections 512-520 described above with respect to FIG. 5B.

In FIG. 5B, block 522 relates to a portion of a manufacturing line in which exterior installs are performed. Example exterior installs relate to the cabin 512, and may include installation of a liftgate, a fascia, a roof, and so on. The cabin assembly line 524 may represent a sub-assembly line associated with the cabin 512. The RUB line 526 may represent a sub-assembly line associated with the RUB 516. As described in FIG. 5B, the RUB 516 may be joined (e.g., joined, attached, and so on as described herein) with the cabin 512. Thus, sub-assembly line 526 may feed into cabin assembly line 524 such that the output of line 524 represents a joined cabin 512 and RUB 516 (e.g., also with exterior installations).

Block 530 relates to attachment of the FUB to the output of line 524, with the FUB 514 being assembled in sub-assembly line 528. Thus, sub-assembly line 528 outputs FUBs for joining with the cabin 512. Block 532 receives the output of block 530, with block 532 attaching the battery pack 518 to the cabin 512. Block 532 receives completed battery packs optionally with seats attached thereto from block 534.

The output of block 532 therefore represents the cabin having an attached FUB 514, RUB 516, and battery pack 518 optionally with seats. Block 536 represents the main line (e.g., general assembly line), and additional manufacturing steps are performed on the substantially completed body or box of the vehicle. For example, block 538 may include installations of doors, a hood, front fascia, and so on.

Thus, FIGS. 5B-5C illustrate example techniques to constrain the manufacturing line by form the vehicle body or box through distinct blocks. Each of the blocks may represent discrete actions which enhance parallelized downstream operation. In this way, the main sections of the vehicle may be manufactured substantially separately and then rapidly joined to form the body or box of the vehicle. As described herein, the main sections may, in some embodiments, be attached via bolting the sections together. For example, one or more robots may be used to fire fasteners (e.g., automated bolt inclusion and fastening) into holes (e.g., bolt holes, threaded holes) to join the sections.

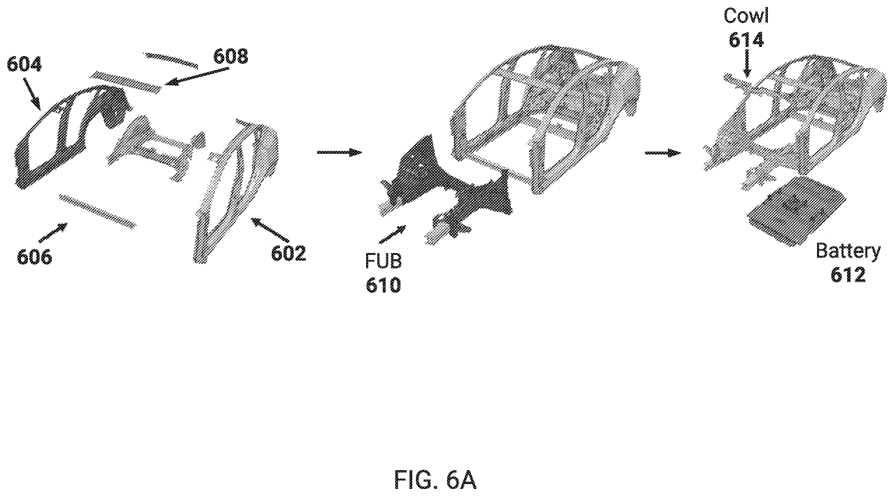

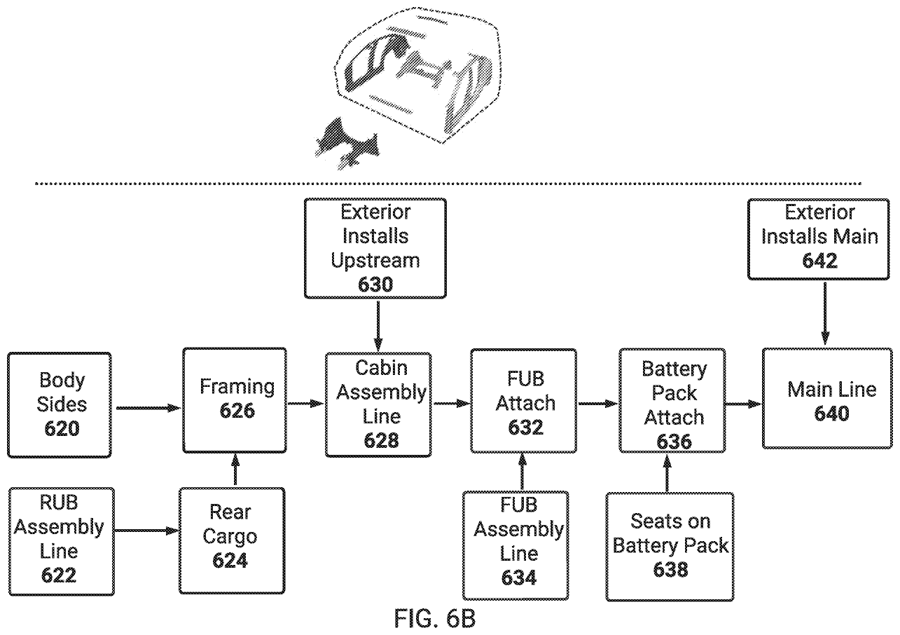

FIGS. 6A-6B illustrates another embodiment of a vehicle architecture according to this disclosure that may partially “unbox” a body frame of a vehicle. The vehicle architecture can be separately prepared (e.g., painted) in sub-lines prior to the assembly steps illustrated in FIG. 6A to improve the efficiency of the process when compared to a traditional assembly process.

In the illustrated embodiment, a partial body frame (e.g., without a front underbody 610, a battery pack 612, and a cowl 614) can be joined together after respective sub-lines. For example, the partial body frame may include the left side 602, right side 604, RUB 606 (e.g., with toe board), and upper support bars 608 being joined. In this example, the RUB 606 may be joined (e.g., bolted) in the x direction, the sides may be bolted in the y direction. Subsequently, the FUB 610 may be joined with the partial body frame (e.g., bolted in the positive x direction). The battery pack 612 and cowl 614 my then be joined to form the body or box as described herein. For example, the battery pack 612 may be joined in the positive z direction and the cowl 614 may be joined in the negative z direction. The vehicle architecture can include joining and fastening (e.g., using bolts) the sections 602-614 in a specific sequence and orientations as illustrated in FIG. 6A. FIG. 6B describes this process in greater detail. As may be appreciated, the directions described above may be adjusted and fall within the scope of the disclosure herein.

FIG. 6B illustrates an example process for manufacturing a vehicle. The illustrated embodiment specifically relates to manufacturing a vehicle using the sections 602-614 described above with respect to FIG. 6A.

In block 620, a sub-assembly line manufactures the body sides of the vehicle. For example, the block 620 may output the left side 602 and right side 604. In some embodiments, block 620 may be separated into two sub-assembly lines with each line manufacturing one of the sides. The left side 602 and right side 604 may, in some embodiments, be single or double door rings to which door panels attach.

In block 622, a sub-assembly line may manufacture the RUB 606. At block 624, rear cargo may be manufactured based on output from block 622. The rear cargo may represent additional elements included in the rear portion of the vehicle and which may be joined with the RUB 606.

In block 626, framing 626 may be performed using output of sub-assembly lines 620 and 624. Framing is illustrated in FIG. 6A on the left-most portion of the figure. For example, framing may include joining of the rear cargo (e.g., FUB) and sides 602-604. As another example, framing may include preparing for the joining (e.g., loading of rear cargo, sides, on pallets). In block 628, the cabin is joined, or otherwise assembled, and exterior elements are installed 630. Example exterior elements may include a liftgate, fascias, roof, cant rail, and so on.

The output of block 628 may be provided to block 632 in which the FUB is joined or otherwise attached. For example, block 632 may receive FUBs from FUB sub-assembly line 634. In block 636, a battery pack is attached to the vehicle being manufactured. In some embodiments, the battery pack may form the bottom or floor of the vehicle such that seats may be joined (e.g., bolted) to the battery pack. These seats may be joined with battery packs in block 638.

Block 640 represents the main line in which the vehicle body or box is substantially finalized. Exterior installs 642 may be performed, with example exterior installs including installation of doors, the hood, front fascia, and so on.

FIGS. 6A-6B, as an example, include additional blocks (e.g., sub-assembly lines) as compared to FIGS. 5B-5C. For example, the vehicle body may be understood to be additionally unboxed (e.g., separated) as compared to FIGS. 5B-5C.

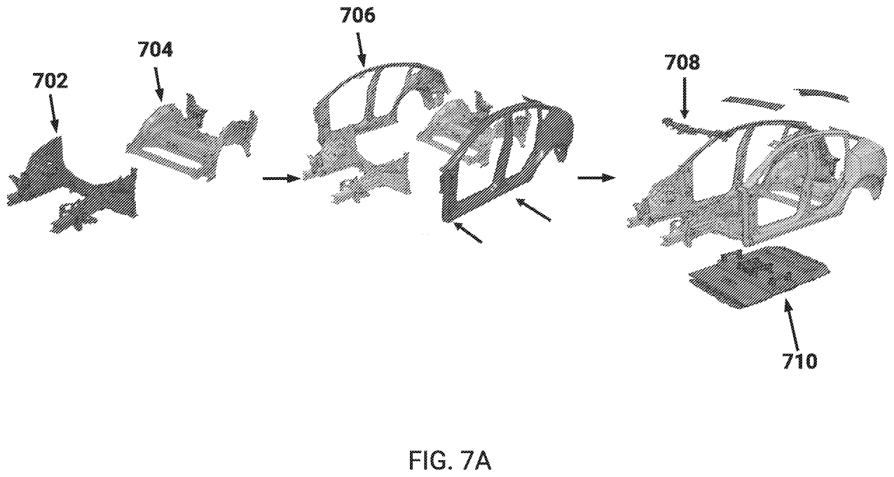

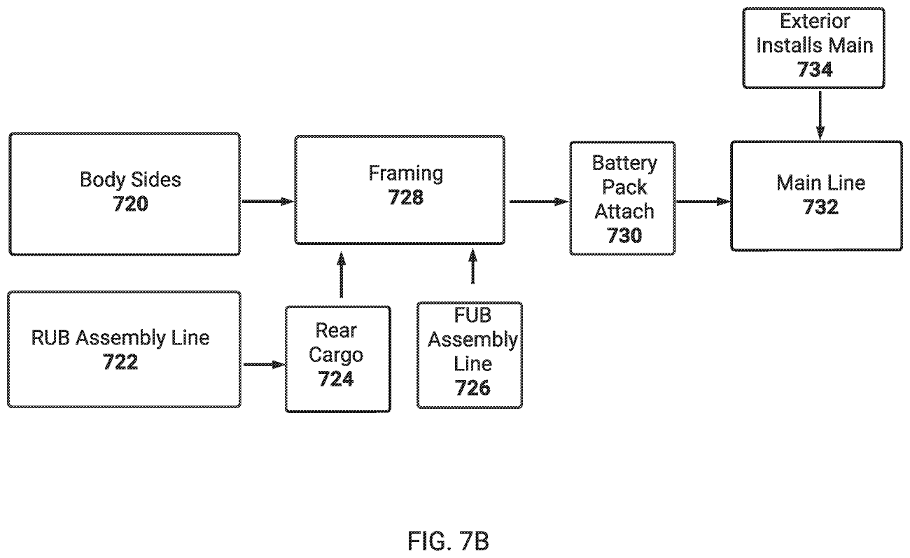

FIGS. 7A-7B illustrates another embodiment of a vehicle architecture according to this disclosure that may completely “unbox” a body frame of a vehicle. The vehicle architecture can be separately prepared (e.g., painted) in sub-lines prior to the assembly to improve the efficiency of the process. In some embodiments, as shown in FIG. 7A, at least a front underbody (FUB) 702 and a rear underbody (RUB) 704 can be loaded on a geo pallet at the end of the sub-lines. Similarly, the vehicle architecture can include joining and fastening (e.g., using bolts) the sections in a specific sequence and orientation as illustrated in FIG. 7A.

For example, the FUB 702 and the RUB 704 may be positioned on the pallets as described above. Subsequently, the sides 706 may be joined (e.g., bolted) in the y-direction. The cowl 708 with the headers and roof bows may then be joined (e.g., fastened or bolted) in the negative z direction. The battery pack 710 may be joined in the positive z-direction. As may be appreciated, the directions described above may be adjusted and fall within the scope of the disclosure herein.

FIG. 7B illustrates an example process for manufacturing a vehicle. The illustrated embodiment specifically relates to manufacturing a vehicle using the sections 702-710 described above with respect to FIG. 6A.

In block 720 the sides of the vehicle are manufactured via one or more sub-assembly lines. For example, single or double door rings may be manufactured. In this example, the single or double door rings may be manufactured with holes or other attachment points. In block 722, the RUB is manufactured via a sub-assembly line and then provided to rear cargo 724. As described above, rear cargo may finalize the RUB assembly. Similarly, the FUB is manufactured in block 726.

In block 728, framing is performed. For example, the vehicle sides, RUB, and FUB are joined together. Advantageously, the joining may be performed via personnel or robots with the joining (e.g., bolting) being performed from the outside of the vehicle towards the inside.

In block 730, the framed vehicle is received a battery pack is attached. In some embodiments, the battery pack may represent a floor of the vehicle such that seats may be joined to the battery pack. In block 732, the vehicle body or box is substantially finalized. In this embodiment, all exterior installs 734 are performed. Example exterior installs include installation of a liftgate, front fascia, rear fascia, cant rail, doors, hood, and so on.

Various embodiments according to this disclosure can involve different levels of “unboxing,” as illustrated in FIGS. 8A-8D, with a different number of sides or “faces,” separately assembled or “unboxed,” prior to joining all faces of the body frame of the vehicle.

For example, FIG. 8A describes a vehicle architecture that can have 2 and ½ of “faces” of a full body frame or “box” of a vehicle separately prepared (e.g., painted) in sub-lines prior to joined into the full body frame of the vehicle. The middle portion shows the different sections without internal components (e.g., vehicle seats) for illustration purposes, while the portion on the right illustrates the sections separately prepared in sub-lines with non-structure components (e.g., vehicle seats) attached and shown. FIG. 8A may thus relate to FIGS. 5B-5C.

Similarly, FIG. 8B describes another embodiment of a vehicle architecture that can have 3 faces of a full body frame of a vehicle “unboxed,” and separately prepared in sub-lines prior to joining into the full body frame. FIG. 8C describes another embodiment of a vehicle architecture that can have 5 faces of a full body frame of a vehicle “unboxed,” and separately prepared in sub-lines prior to joining into the full body frame. FIG. 8D describes another embodiment of a vehicle architecture that can have all 6 faces of a full body frame of a vehicle “unboxed,” and separately prepared in sub-lines prior to joining into the full body frame. FIG. 8D may therefore relate to FIGS. 6A-7B.

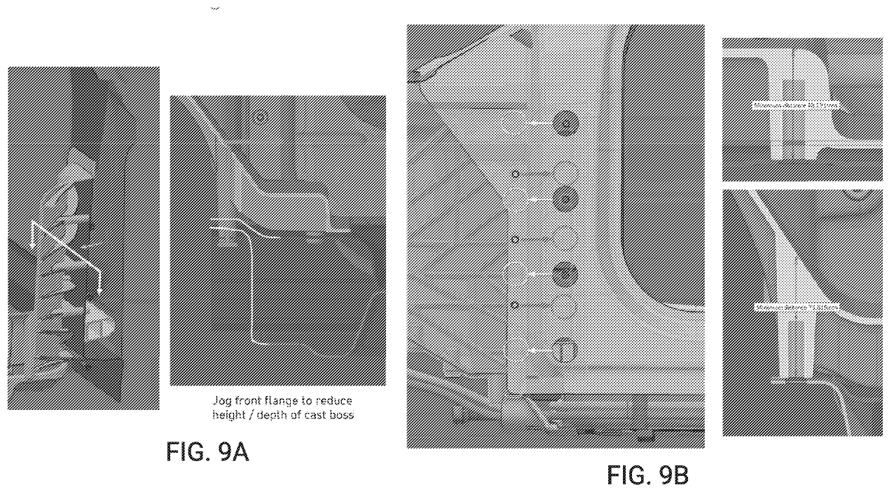

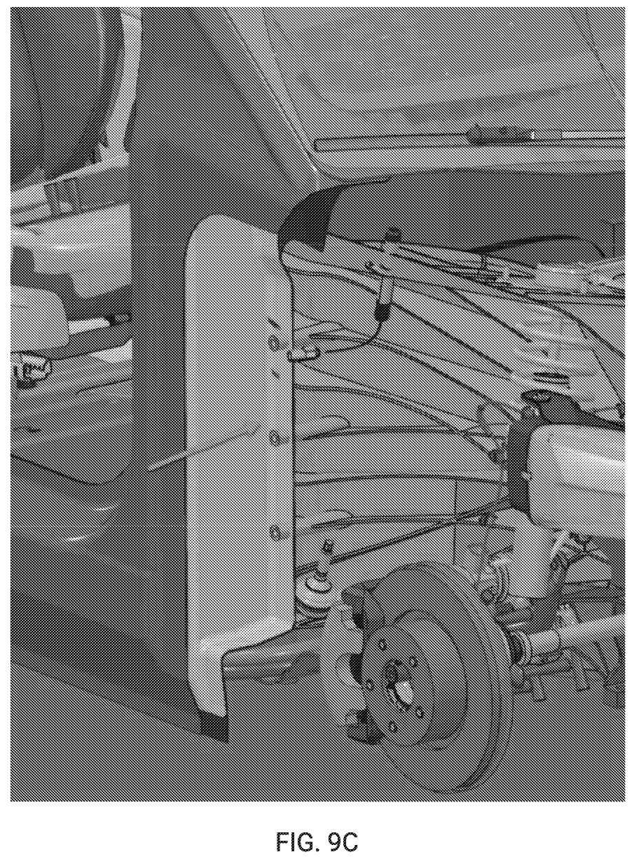

With respect to joining and/or fastening sections, in some embodiments bolts may be used. FIG. 9A illustrates a stamped hinge pillar section with a jogged inboard mounting flange to minimize the depth of mating cast component features. FIG. 9B illustrates a staggered bolt pattern (e.g., in side views), with the bolt positions varying in the longitudinal (x) and vertical (z) directions, and installed in the lateral (y) direction, to increase vertical (z) moment capacity of the hinge pillar joint. FIG. 9C illustrates a stamped hinge pillar section with the flange moved inboard to reduce the depth of cast features.

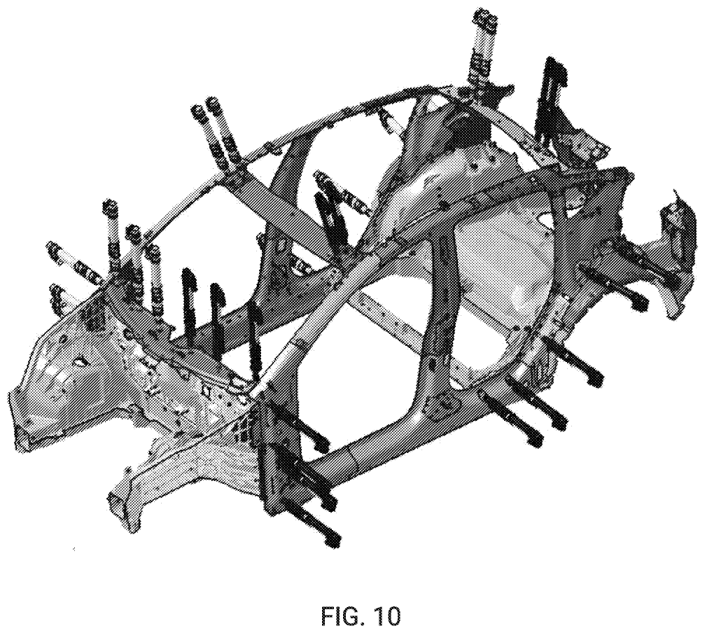

FIG. 10 illustrates a joining technique that can be used to join the faces of a vehicle body frame. For example, FIG. 10 illustrates using a multitude of bolts to join sections of the vehicle body. In this example, the bolts may be applied by personnel or by robots. The joining technique can include biasing tooling towards the exterior of the vehicle with clear line of sight so that the vehicle can be framed with substantial general assembly content.

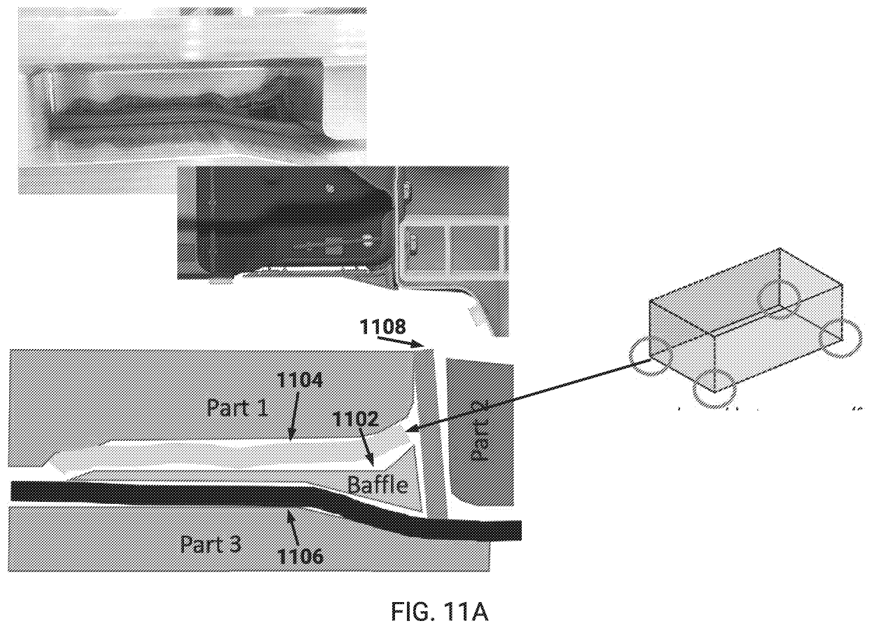

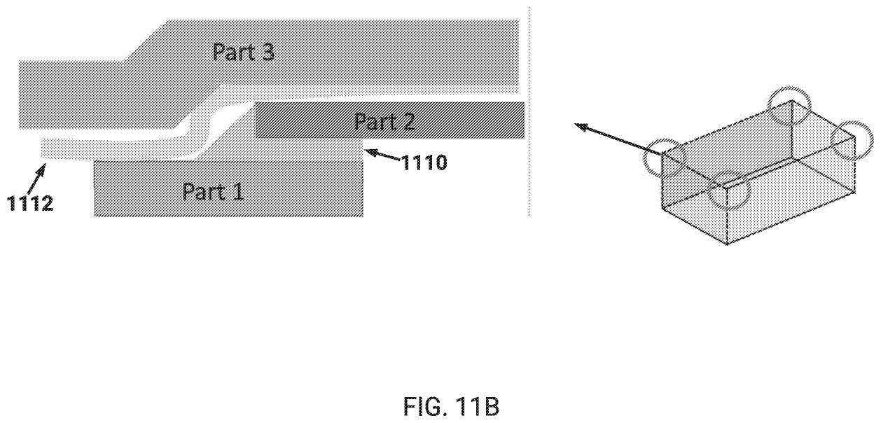

A vehicle architecture according to this disclosure can also include sealing techniques that may be used at different locations, at corners and edges between faces of a vehicle body frame as shown in FIGS. 11A-11B. In some embodiments, as illustrated in FIG. 11A, a sealing technique according to this disclosure can include using a baffle 1102 to fill a void that occurs at mating faces. To eliminate the need for a skiving operation, a material 1104 can be tuned to bridge the gap without creating a pinhole. In some embodiments, for example, a heat activated expansion material can be employed to overexpand so as to fill the gap followed by application of a urethane or another pumpable material 1106-1108 to make a contiguous joint.

As shown in FIG. 11B, in other embodiments, a sealing technique according to this disclosure can also include dispensing an uncured bead of urethane 1110 or other pumpable across two joining sections, ensuring that squeeze-out occurs at the end. The scaling technique can further include attaching a mating component on top of the joint which also has a dispensed uncured pumpable material 1112.

Various embodiments of a modular vehicle architecture disclosed herein can relate to different types of vehicles. For example, sedans are illustrated in certain figures while a pick-up truck is illustrated in other figures. A person with ordinary skills in the art can appreciate that various module vehicle architectures according to this disclosure can be applied to various types of vehicles, for example, a sedan, a pickup truck, a sport utility vehicle (SUV), a boat, an airplane, and so on.

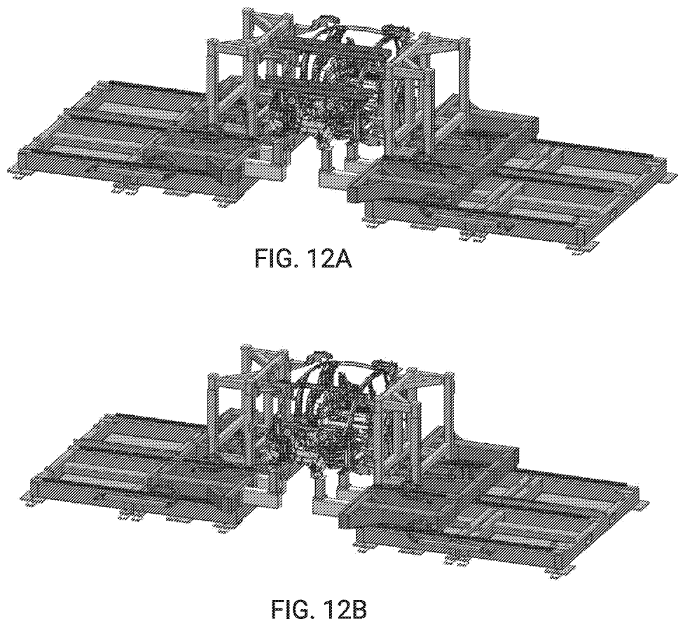

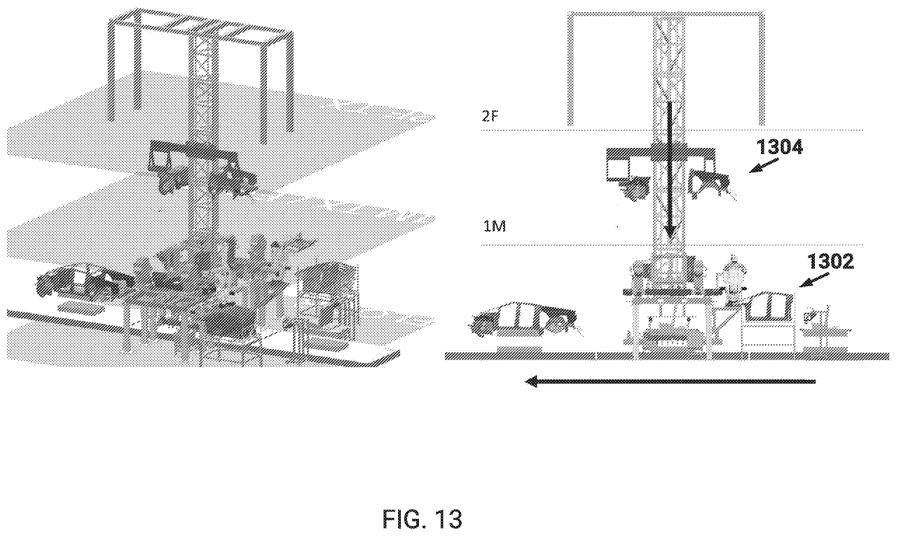

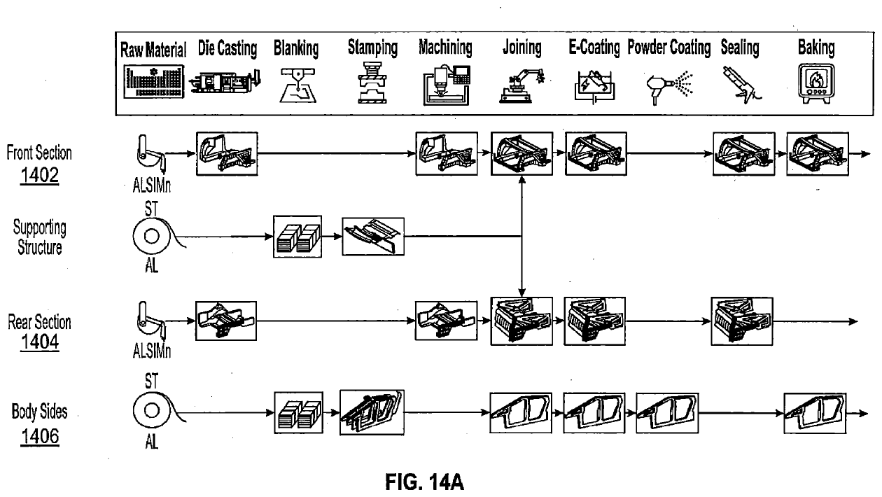

FIGS. 12A-12B and 13 illustrate examples of framing or joining sections of the vehicle. For example, FIG. 13 illustrates automated framing via a frame station in which portions may be joined in different directions. In the illustrated example, a side 1302 may be joined in a particular direction while other sections 1304 are joined in a different direction (e.g., negative z direction).

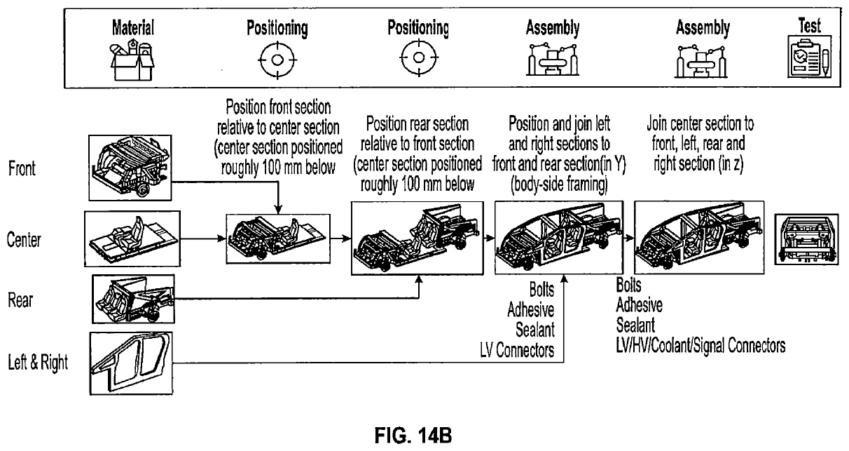

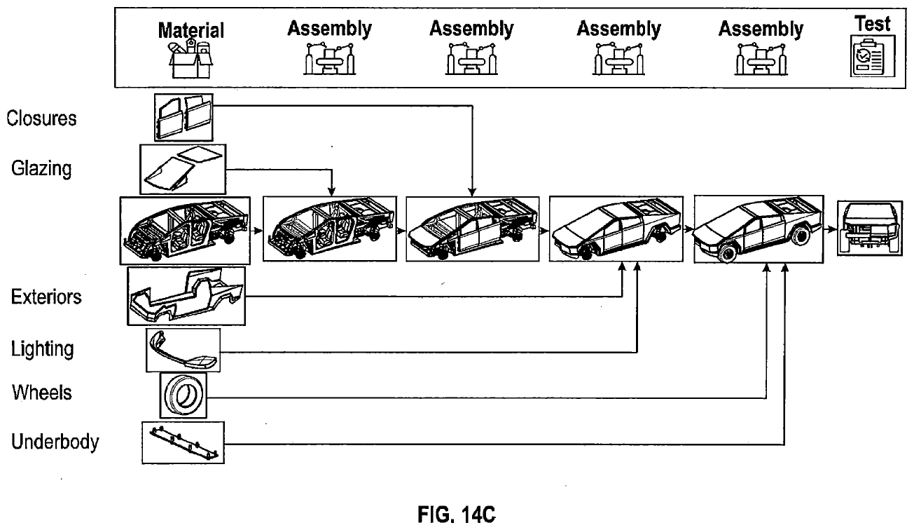

FIGS. 14A-14C illustrate example processes by which a vehicle may be manufactured. In FIG. 14A, certain main sections are illustrated as being fabricated or manufactured. In the example, the sections include the front section 1402 (e.g., the FUB), the rear section 1404 (the RUB), and the sides 1406. In FIG. 14A, each section is illustrated as traversing through manufacturing steps including, raw material, die casting, blanking, stamping, machining, joining, decorating (e.g., e-coating, powder coating), sealing, and baking. Thus, the output of this portion represents sections which are then joinable as described herein. In some embodiments, discrete sub-assembly lines may be used to manufacture the pieces.

FIG. 14B illustrates the main sections of FIG. 1, such as the front, center, rear, and sides (e.g., left and right). Specifically, the figure describes the example steps to position each section and then assemble them into a vehicle. As described herein, this may be performed using discrete sub-assemblies.

FIG. 14C illustrates finishing the vehicle by adding windows, exterior elements, lighting, wheels, and so on.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed systems and processes. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first,” “second,” “third,” “primary,” “secondary,” “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A method for assembling a vehicle, the method comprising:
preparing a plurality of individual sections of a vehicle in a plurality of sub-assembly lines prior to forming a full body frame of the vehicle; and
joining the plurality of individual sections of the vehicle in a mainline,
wherein the full body frame of the vehicle comprises a front side, a rear side, a top side, a bottom side, a left side, and a right side.

2. The method of claim 1, wherein joining does not include welding the sections together.

3. The method of claim 1, wherein joining comprises bolting at least a subset of the sections together at a same time.

4. The method of claim 1, wherein joining the individual sections comprises:
joining the left side, the right side, the top side, and the rear side, to form a cabin of the vehicle,
then, joining the front side to the cabin,
and then joining a battery pack.

5. The method of claim 4, wherein the battery pack has seats attached thereto.

6. The method of claim 4, wherein the mainline installs exterior elements, and wherein the exterior elements comprise one or more of doors, a hood, and front fascia.

7. The method of claim 1, wherein joining the individual sections comprises:
joining the left side, the right side, the top side, and the rear side to form a cabin of the vehicle,
then, joining the front side to the cabin,
and then joining a battery pack.

8. The method of claim 1, wherein joining the individual sections comprises:
loading the front section and the rear section onto movable pallets,
then, joining the left side and the right side to the front section and the rear section to form a cabin of the vehicle,
and then, joining the top section and a battery pack to the cabin.

9. The method of claim 8, wherein exterior installs are performed subsequent to joining, and wherein the exterior installs comprise one or more of installing a liftgate, a fascia, a roof, a cant rail, one or more doors, and a hood.

10. The method of claim 1, wherein each individual section is decorated prior to joining 11. A vehicle assembling line comprising:
a plurality of sub-assembly lines configured to at least decorate a plurality of individual sections of a vehicle,
a mainline configured to join the plurality of individual sections of the vehicle to form a full body frame of the vehicle,
wherein the full body frame of the vehicle comprises a front side, a rear side, a top side, a bottom side, a left side, and a right side.

12. The vehicle assembling line of claim 11, wherein joining does not include welding the sections together.

13. The vehicle assembling line of claim 11, wherein joining comprises bolting at least a subset of the sections together at a same time.

14. The vehicle assembling line of claim 11, wherein joining the individual sections comprises:
joining the left side, the right side, the top side, and the rear side, to form a cabin of the vehicle,
then, joining the front side to the cabin,
and then joining a battery pack.

15. The vehicle assembling line of claim 14, wherein the battery pack has seats attached thereto.

16. The vehicle assembling line of claim 14, wherein the mainline installs exterior elements, and wherein the exterior elements comprise one or more of doors, a hood, and front fascia.

17. The vehicle assembling line of claim 11, wherein joining the individual sections comprises:
joining the left side, the right side, the top side, and the rear side to form a cabin of the vehicle,
then, joining the front side to the cabin,
and then joining a battery pack.

18. The vehicle assembling line of claim 11, wherein joining the individual sections comprises:
loading the front section and the rear section onto movable pallets,
then, joining the left side and the right side to the front section and the rear section to form a cabin of the vehicle,
and then, joining the top section and a battery pack to the cabin.

19. The vehicle assembling line of claim 18, wherein exterior installs are performed subsequent to joining, and wherein the exterior installs comprise one or more of installing a liftgate, a fascia, a roof, a cant rail, one or more doors, and a hood.

20. The vehicle assembling line of claim 11, wherein each individual section is decorated prior to joining.
